(19) United States
(12) Patent Application Publication
(10) Pub. No.: US 2004/0059011 A1
(43) Pub. Date: Mar. 25, 2004

(54) Aromatic polyester polyols

(76) Inventors: Thomas Allan Barber, Hendersonville, TN (US); Thomas Roy McClellan, Conroe, TX (US); Melanie McClellan, (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/619,722

(22) Filed: Jul. 15, 2003

Related U.S. Application Data
(60) Provisional application No. 60/397,408, filed on Jul. 19, 2002.

(51) Int. Cl. C08G 18/00; C08G 63/02

(52) U.S. Cl. 521/99; 521/155; 528/272

(57) ABSTRACT

Aromatic polyester polyols, and foams produced therefrom, having an acid number below 3.0 mg/KOH/g, wherein the aromatic polyester polyol is the reaction product of a reaction mixture comprising an acid component, a glycol component, and a urethane catalytic activity agent comprising at least one of a non-alkoxylated aminoalcohol and a metal esterification catalyst.

### BACKGROUND OF THE INVENTION

The present invention relates to polyols useful for making foams. More particularly, the invention relates to aromatic polyester polyols having urethane catalytic activity.

It is known to prepare polyurethane and polyisocyanurate foams by the reaction of a polyisocyanate, a polyol, and a blowing agent such as a hydrocarbon, water, or both, in the presence of a urethane catalyst. Polyols useful for making polyurethane and polyisocyanurate foams are well known in the art.

U.S. Pat. No. 4,681,903 to Haas et al. teaches certain nitrogen-containing, relatively low-viscosity polyester polyols useful in the production of polyurethane and polyisocyanurate foams. These polyols are obtained by reacting (a) a dicarboxylic acid, derivative thereof, or anhydride thereof with (b) a tri-alkanolamine and/or tetrakis-alkanol diamine in a molar ratio of (a) to (b) of from 1:1.2 to 1:2. The polyols of Haas et al. are predominantly aliphatic polyester polyols, as Haas et al. teaches at column 5, lines 52-55 and Example 3 that aromatic dicarboxylic acids are preferably used in only small quantities so that liquid polyester polyol derivatives are obtained.

U.S. Pat. No. 5,360,900 to DeLeon et al. is directed to methods for preparing polyester-polyether polyols from polyalkylene terephthalates. The polyester-polyether polyols of DeLeon et al. reportedly have high functionality (2.3-3.0), high aromatic content (34-42%), a conventional viscosity (ranging between 3,000 to 25,000 cps at 25° C.), and are especially useful for making polyurethane and polyisocyanurate foams with improved thermal stability and insulation values.

U.S. Pat. No. 6,133,329 to Shieh et al. is directed to methods of making aromatic polyester polyols that are suitable for use with hydrocarbon and hydrofluorocarbon blowing agents. The polyols are made by reacting polyethylene terephthalate, dissolved in a solution comprising a plurality of glycols, with a natural oil. The natural oil reacts into the polyol backbone at a specific temperature. The polyols reportedly exhibit low hydroxyl numbers and low viscosities, and hydrocarbons and hydrofluorocarbons blowing agents are soluble in these polyols.

U.S. Pat. No. 4,753,967 to Londrigan and U.S. Pat. No. 4,714,717 to Londrigan et al. are directed to polyester polyols suitable for use in a foam-forming reaction with an organic polyisocyanate in the manufacture of a polyurethane or polyisocyanurate foam, the polyester polyols being the reaction product of polycarboxylic acid and certain polyol components.

U.S. Pat. No. 4,642,319 to McDaniel is directed to the preparation of isocyanurate foams from a recycled polyethylene terephthalate polyol modified with aromatic amino polyols, sucrose polyols, ethoxylated alphamethyl glucosides, alkoxylated glycerine, or alkoxylated sorbitol. These modified foams reportedly exhibit improved fluorocarbon solubility.

U.S. Pat. No. 4,902,816 to McDaniel is directed to polyols containing polyether and polyester moieties, based on phthalic acid. A phthalic acid derivative is reacted with a polyether polyol to give polyols, which are reportedly useful in polyisocyanurate and polyurethane foams.

U.S. Pat. No. 4,760,100 to McDaniel is directed to the preparation of isocyanurate foams from a recycled polyethylene terephthalate polyol modified with alkoxylated amines and alkoxylated amides. These modified foams reportedly exhibit improved fluorocarbon solubility, and the resultant polyols are difunctional.

U.S. Pat. No. 4,720,571 to Trowell is directed to a mixture of terephthalic acid ester polyols for use in the preparation of rigid polyurethane and polyisocyanurate foams. The polyols are prepared by reacting scrap polyethylene terephthalate, dimethyl terephthalate process residue, and an excess mixture of glycols.

U.S. Pat. No. 4,444,918 to Brennan is directed to mixtures of aromatic polyols containing ester functionalities suitable for use in rigid foams prepared by reacting dibasic acid residues with an alkylene glycol residue, the reaction product of which is reacted with terephthalic acid residues. These polyols reportedly may be blended with conventional polyols to yield excellent rigid foams, thus serving as useful polyol extenders.

U.S. Pat. No. 4,442,237 to Zimmerman et al. teaches mixtures of aromatic polyols containing tertiary amine and ester functionalities suitable for use in rigid foam prepared by reacting a phthalic acid residue with an alkylene glycol and an amino alcohol. It is reported in Zimmerman et al. that the polyols may be blended with conventional polyols to yield rigid polyurethane foams with better flammability resistance as compared with foams made from conventional polyols alone. Zimmerman et al. teaches that the polyols of their invention may be used as the sole polyol component in a polyurethane foam formulation, but that it is preferable to blend the polyol with conventional polyols.

The examples of Zimmerman et al. exemplify the use of non-alkoxylated aminoalcohols (Examples IV-VIII) and alkoxylated aminoalcohols (Examples IV-VIII). Alkoxylated aminoalcohols suffer from very high expense as compared to non-alkoxylated aminoalcohols and, thus, non-alkoxylated aminoalcohols are generally preferred where cost is a factor. In the non-alkoxylated aminoalcohol examples, Zimmerman et al. achieves a polyol having a hydroxyl number of 268 and acid number of 5.61 using 0.99 meq/g of amine (Example I), hydroxyl number of 350 and acid number of 3 using 0.9 meq/g of amine (Example II), and hydroxyl number of 154 and acid number of 9 using 1.9 meq/g of amine. Zimmerman et al. does not exemplify a polyol having an acid number below 3.0 made using a non-alkoxylated aminoalcohol.

With the possible exceptions of the polyols disclosed in U.S. Pat. No. 4,681,903 to Haas et al. and U.S. Pat. No.4,442,237 to Zimmerman et al., the known polyols all require the use of a polyurethane catalyst to achieve a suitable polyurethane foam. Polyurethane catalysts conventionally employed to catalyze the reaction of an isocyanate with a polyol include organic and inorganic acid salts of, coordination complexes of, and organometallic derivatives of, bismuth, lead, tin, iron, antimony, uranium, cadmium, cobalt, thorium, aluminum, mercury, zinc, nickel, cerium, molybdenum, vanadium, copper, manganese, titanium, and zirconium, as well as phosphines and tertiary organic amines. To satisfy the needs for lower costs and lower temperature foam processing advantages, there remains a need for aromatic polyester polyols having inherent urethane catalytic activity, i.e., wherein a polyurethane and/or polyisocyanurate foam can be prepared by reacting the aromatic polyester polyol with a polyisocyanate, blowing agent, and, optionally, further additives or surfactants, without the need to add a urethane catalyst or at least to minimize the quantity to be added.

### SUMMARY OF THE INVENTION

The invention is directed to aromatic polyester polyols having an acid number below 3.0 mg/KOH/g, wherein the aromatic polyester polyol is the reaction product of a reaction mixture comprising (a) an acid component, (b) a glycol component, and (c) a urethane catalytic activity agent that comprises a non-alkoxylated aminoalcohol. Preferably, the urethane catalytic activity agent of the reaction mixture comprises a non-alkoxylated tertiary aminoalcohol. In another preferred embodiment, the urethane catalytic activity agent further comprises a metal esterification catalyst. In one embodiment, the aromatic polyester polyols have a polyurethane foam reaction polymerization rate that is increased by at least 50% by the presence of the urethane catalytic activity agent.

The invention also includes an aromatic polyester polyol having an acid number below 3.0 mg/KOH/g, wherein the aromatic polyester polyol is the reaction product of a reaction mixture comprising (a) an acid component, (b) a glycol component, and (c) a urethane catalytic activity agent comprising at least one of a non-alkoxylated aminoalcohol and a metal esterification catalyst, wherein:

(i) the aromatic polyester polyol has a polyurethane foam reaction polymerization rate in an HCFC-141b blown system that is increased at least 367% by the presence of the urethane catalytic activity agent;

(ii) the aromatic polyester polyol has a polyurethane foam reaction polymerization rate in a water/hydrocarbon co-blown system that is increased at least 295% by the presence of the urethane catalytic activity agent; or

(iii) the aromatic polyester polyol has a polyurethane foam reaction polymerization rate in a water blown system that is increased by the presence of the urethane catalytic activity agent.

In one embodiment, the polyurethane foam reaction polymerization rate is increased at least 400% by the presence of the urethane catalytic activity agent. Preferably, the urethane catalytic activity agent comprises a non-alkoxylated aminoalcohol and a metal esterification catalyst.

The aromatic polyester polyols of the invention preferably have an average hydroxyl functionality less than 4.0, more preferably 2.0 to 4.0. In addition, the aromatic polyester polyols preferably have an acid number of 0.1 to 2.98 mg/KOH/g. Furthermore, the aromatic polyester polyols preferably have a hydroxyl value of 250-600 mg/KOH/g. The aromatic polyester polyols also preferably have a Kinematic viscosity at 25° C. of 2,500-100,000 cSt.

The invention also includes a blend comprising (i) one or more blowing agents, surfactants, catalysts, or a combination thereof and (ii) an aromatic polyester polyol of the invention.

The invention further includes polyisocyanurate foams prepared from the aromatic polyester polyols of the invention. Preferably, these polyisocyanurate foams comprise the reaction product of an organic polyisocyanate, a blowing agent, a surfactant, at least one trimerization catalyst, and an aromatic polyester polyol of the invention. In one embodiment, the polyisocyanurate foam has a NCO index of 1.44.5.

The invention also includes polyurethane foams prepared from the aromatic polyester polyols of the invention. Preferably, these polyurethane foams comprise the reaction product of an organic polyisocyanate, a blowing agent, a surfactant, and an aromatic polyester polyol of the invention. The reaction composition producing the polyurethane foam can further comprise a polyurethane catalyst. In one embodiment, the polyurethane foam has a NCO index of 0.8-1.4.

The invention also includes a process for producing an aromatic polyester polyol having an acid number below 3.0 mg/KOH/g, the process comprising reacting, at a temperature greater than 150° C., a reaction mixture comprising (a) an acid component, (b) a glycol component, and (c) a urethane catalytic activity agent that comprises a non-alkoxylated aminoalcohol. A further process of the invention for producing an aromatic polyester polyol having an acid number below 3.0 mg/KOH/g comprises reacting, at a temperature greater than 150° C., a reaction mixture comprising (a) an acid component, (b) a glycol component, and (c) a urethane catalytic activity agent comprising at least one of a non-alkoxylated aminoalcohol and a metal esterification catalyst, wherein:

(i) the aromatic polyester polyol has a polyurethane foam reaction polymerization rate in an HCFC-141b blown system that is increased at least 367% by the presence of the urethane catalytic activity agent;

(ii) the aromatic polyester polyol has a polyurethane foam reaction polymerization rate in a water/hydrocarbon co-blown system that is increased at least 295% by the presence of the urethane catalytic activity agent; or

(iii) the aromatic polyester polyol has a polyurethane foam reaction polymerization rate in a water blown system that is increased by the presence of the urethane catalytic activity agent.

In the processes of the invention, the acid component preferably comprises at least one of (a) ester-containing by-products from the manufacture of dimethyl terephthalate, (b) scrap polyalkylene terephthalates, (c) phthalic anhydride, (d) residues from the manufacture of phthalic anhydride, (e) terephthalic acid, (f) residues from the manufacture of terephthalic acid, (g) isophthalic acid, (h) trimellitic anhydride and residue from the manufacture of, (i) aliphatic polybasic acids or esters derived therefrom, and (j) by-products from the manufacture of polyalkylene terephthalate. In another embodiment of these processes, the glycol preferably comprises ethylene glycol, propylene glycol, diethylene glycol, triethylene glycol, polyethylene glycol, dipropylene glycol, or a mixture thereof. In one embodiment, the step of reacting is preferably at 80 to 250° C. In another embodiment, the step of reacting comprises (i) an initial reaction at a pressure from 560 mmHg to atmospheric pressure and (ii) a completion reaction at a vacuum pressure of 50 to 200 mmHg or an azeotrope distillation using cyclohexane. In a preferred embodiment, the initial reaction is greater than 50% of the total reacting, more preferably greater than 85%. Preferably, the metal esterification catalyst comprises manganese acetate, antimony oxide, lead oxide, tin chloride, tin oxide, a titanate, or a combination thereof. In addition, it is preferable that the non-alkoxylated aminoalcohol is a non-alkoxylated tertiary aminoalcohol, more preferably triethanolamine. In one embodiment, the reaction mixture further comprises a functionality enhancing component having a hydroxyl equivalent weight of 15 to 70. The functionality enhancing component preferably comprises a non-alkoxylated glycerol, pentaerythritol, α-methylglucoside, sucrose, sorbitol, tri-methylolpropane, trimethylolethane, a tertiary aminoalcohol, or a mixture thereof.

The invention further includes a process for making a foam, comprising reacting an aromatic polyester polyol of the invention with an organic polyisocyanate in the presence of a surfactant and a blowing agent.

The invention also includes a process for making a foam that comprises the steps of:

(a) obtaining an aromatic polyester polyol having an acid number below 3.0 mg/KOH/g, wherein the aromatic polyester polyol is the reaction product of a reaction mixture comprising: an acid component; a glycol component; and a metal esterification catalyst, wherein the reaction product further comprises at least one of residue metal esterification catalyst and glycolates, carboxylates, and other coordination compounds of the metal; and

(b) reacting the aromatic polyester polyol with an organic polyisocyanate in the presence of a surfactant and a blowing agent,

wherein at least one of the residue metal esterification catalyst and glycolates, carboxylates, and other coordination compounds of the metal is not substantially removed prior to the step of reacting. In a preferred embodiment, the reaction mixture further comprises a non-alkoxylated aminoalcohol.

### DETAILED DESCRIPTION OF THE INVENTION

The invention provides aromatic polyester polyols having urethane catalytic activity. It has been discovered that, by reacting an acid component and a glycol component with a urethane catalytic activity agent as described herein, the resulting aromatic polyester polyol has urethane catalytic activity. More specifically, it has been discovered that the polyurethane foam reaction polymerization rate of the aromatic polyester polyol is dramatically increased due to the presence of the urethane catalytic activity agent(s) reacted with the acid component and the glycol component in forming the aromatic polyester polyol.

As used herein, the “polyurethane foam reaction polymerization rate” is defined as the time, measured from the beginning of mixing of the aromatic polyester polyol and isocyanate components, to reach the degree of polymerization wherein a fiber or string of polymer can be drawn from the reacting mass of the polymer. In the examples provided below, the polyurethane foam reaction polymerization rate is equal to the foam gel time in seconds.

The urethane catalytic activity agents of the invention comprise at least one of a non-alkoxylated aminoalcohol and a metal esterification catalyst.

When the urethane catalytic activity agent includes a non-alkoxylated aminoalcohol, it is believed that the aminoalcohol is ester-linked to the aromatic polyester polyol, thereby providing a nitrogen-containing aromatic polyester polyol having urethane catalytic activity. The aminoalcohols used herein are non-alkoxylated aminoalcohols which, as used herein, is intended to mean that the amine itself may be alkoxylated but the resulting aminoalcohol does not contain additional alkoxylation to the base aminoalcohol by reaction with an alkylene oxide such as ethylene oxide, propylene oxide, butylene oxide and the like. Examples of suitable non-alkoxylated aminoalcohols, used either individually or in mixture, are the N-alkylalkanolamines and alkanolamines where the alkyl groups are methyl, ethyl, propyl, isopropyl, isobutyl, or butyl. Preferably, the non-alkoxylated aminoalcohol urethane catalytic activity agent is a tertiary amine. Examples of suitable tertiary amines are n-methyldiethanolamine, n-propyldiethanolamine, n-isopropyidiethanolamine, n-butyidiethanolamine, n-isobutyidiethaolamine, triisopropanolamine, triethanolamine, tripropanolamine, tributanolamine, triisobutanolamine, and the like. In a preferred embodiment, the non-alkoxylated aminoalcohol is triethanolamine or the column bottoms from purification of triethanolamine.

When the urethane catalytic activity agent includes a metal esterification catalyst, it is believed that the metal from the metal esterification catalyst attaches to the aromatic polyester polyol and/or forms a chelate, producing an aromatic polyester polyol having urethane catalytic activity. The resulting aromatic polyester polyol, in some instances, will include residue metal esterification catalyst and glycolates, carboxylates, and other coordination compounds of the metal. The metal resulting in urethane catalytic activity is intended to include organic and inorganic acid salts of, coordination complexes of, and organometallic derivatives of the metal esterification catalyst. Useful organic and inorganic salts of, coordination complexes of and organometallic derivatives include those of bismuth, lead, tin, titanium, iron, antimony, uranium, cadmium, cobalt, thorium, aluminum, mercury, zinc, nickel, cerium, molybdenum, vanadium, copper, manganese, titanium, and zirconium. Examples of suitable metal esterification catalysts include bismuth nitrate, lead 2-ethylhexoate, lead benzoate, lead oleate, dibutyltin dilaurate, tributyltin, butyltin trichloride, stannic chloride, stannous octoate, stannous oleate, dibutyltin di (2-ethylhexoate), ferric chloride, antimony trichloride, antimony glycolate, and tin glycolate. In a preferred embodiment, the metal esterification catalyst comprises manganese acetate, antimony oxide, tin chloride, tin oxide, a titanate, or a combination thereof.

In addition to the urethane catalytic activity agent, the reaction mixture for forming the polyols of the invention further comprises an acid component and a glycol component.

The acid component can include a carboxylic acid or acid derivative, such as an anhydride or ester of the carboxylic acid. Examples of suitable carboxylic acids and derivatives thereof useful as the acid component for the preparation of the aromatic polyester polyol include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester. While the acid component can be a substantially pure reactant material, the acid component is preferably a side-stream, waste, or scrap residue from the manufacture of phthalic acid, terephthalic acid, dimethyl terephthalate, polyethylene terephthalate, polybutylene terephthalate, polytrimethylene terephthalate, adipic acid, and the like. Preferred aromatic carboxylic acid components include ester-containing by-products from the manufacture of dimethyl terephthalate, scrap polyalkylene terephthalates, phthalic anhydride, residues from the manufacture of phthalic anhydride, terephthalic acid, residues from the manufacture of terephthalic acid, isophthalic acid, trimellitic anhydride, residue from the manufacture of trimellitic anhydride, aliphatic polybasic acids or esters derived therefrom, scrap resin from the manufacture of biodegradable polymers such as Biomax® (E. I. du Pont de Nemours and Company, Wilmington, Del.), and by-products from the manufacture of polyalkylene terephthalate.

The glycol component can be aliphatic, cycloaliphatic, aromatic and/or heterocyclic, and is preferably a diol, triol, or tetrol. Preferably, the glycol component is an aliphatic dihydric alcohol having no more than about 20 carbon atoms. In one embodiment, the glycol comprises ethylene glycol, propylene glycol, diethylene glycol, triethylene glycol, polyethylene glycol, dipropylene glycol, or a mixture thereof. Suitable polyol side-stream sources include ethylene glycol, diethylene glycol, triethylene glycol, and higher homologs or mixtures thereof. The similar homologous series of propylene glycols can also be used. Glycols can also be generated in situ during preparation of the aromatic polyester polyols of the invention by depolymerization of polyalkylene terephthalates. For example, polyethylene terephthalate yields ethylene glycol. The glycol component optionally may include substituents which are inert in the reaction, such as chlorine and bromine substituents, and/or may be unsaturated. Low molecular weight polyhydroxy compounds containing 3 to about 8 hydroxy groups to be used in accordance with the present invention will suitably have an average molecular weight of about 90 to about 350 and, as indicated, a functionality of about 3 to 8. Illustrative of the polyhydroxy compounds that can be used alone or in admixture are compounds such as alpha methyl glucoside, glycerol, trimethylol propane, pentaerythritol, sorbitol, and low protein, aldehyde-free sugars such as xylose, mannitol, and sorbitol.

As used herein, the aromatic polyester polyols of the invention have, as a molar percentage of the acid component, a molar aromatic content of at least 10%, i.e., have an molar aliphatic acid content of 90% or less. Preferably, the aromatic acid portion of the total acid is at least 40 mol %, more preferably 100 mol %. The aromatic polyester polyols of the invention include minor amounts, if any, of unreacted glycols or polyhydroxy compounds remaining after the preparation of the aromatic polyester polyol. In a preferred embodiment of the invention, residue metal esterification catalyst and glycolates, carboxylates, and other coordination compounds of the metal resulting from formation of the aromatic polyester polyol are not substantially removed prior to reacting the aromatic polyester polyol with the other components used in making the foam. The term “substantially removed” is intended to mean that the residue metal esterification catalyst and glycolates, carboxylates, and other metal compounds thereof are not intentionally removed from the aromatic polyester polyol. Thus, at least 10%, preferably at least 50%, more preferably at least 90% of the residue metal esterification catalyst and glycolates, carboxylates, and other coordination compounds of the metal resulting from formation of the aromatic polyester polyol are not removed prior to reacting the aromatic polyester polyol with the other components used in making the foam.

In one embodiment, the aromatic polyester polyols of the invention have an average hydroxyl functionality of at least 2.0, preferably at least 2.5, more preferably at least 3.0. The aromatic polyester polyols of the invention also preferably have a Kinematic viscosity at 25° C. of 2500-100,000 cSt, more preferably a Kinematic viscosity at 25° C. of 3000-25,000 cSt. In addition, the aromatic polyester polyols of the invention preferably have a hydroxyl value of 250-600 mg/KOH/g, more preferably 300-450 mg/KOH/g.

The reaction mixture used to form the aromatic polyester polyols of the invention can optionally further include a functionality enhancing component, which can be added to increase the hydroxyl functionality of the resulting aromatic polyester polyol. Examples of functionality enhancing components include non-alkoxylated glycerol, pentaerythritol, α-methylglucoside, sucrose, sorbitol, tri-methylolpropane, trimethylolethane, a tertiary alkynol amine, various mono-di, tri, and polysaccharides or a mixture thereof.

The aromatic polyester polyols of the invention can be prepared using conventional techniques known to those skilled in the art. The process for forming the aromatic polyester polyols of the invention can comprise reacting, at a temperature greater than 150° C., a reaction mixture comprising an acid component, a glycol component, and a urethane catalytic activity agent comprising at least one of a non-alkoxylated aminoalcohol and a metal esterification catalyst. In a preferred embodiment, the reaction mixture is reacted in two stages: (i) an initial reaction at a pressure of 560 mmHg to atmospheric pressure and (ii) a completion reaction at a vacuum pressure of 50 mmHg to 200 mmHg or an azeotrope distillation using cyclohexane. In a preferred embodiment, the initial reaction is driven to greater than 50%, preferably greater than 85%, of the total reacting.

The invention also includes foams made from the aromatic polyester polyols of the invention, particularly polyurethane and polyisocyanurate foams. The polyurethane and polyisocyanurate foams of the invention can be prepared by conventional techniques that include reacting an aromatic polyester polyol of the invention and an organic polyisocyanate in the presence of a surfactant and a blowing agent.

The polyurethane foams of the invention preferably have a NCO index of 0.8 to 1.3. The polyisocyanurate foams of the invention have a NCO index of 1.34.5, preferably 1.3-3.5, more preferably 1.3-2.5. NCO index is the molar ratio of isocyanate reactive groups (NCO) to overall polyol and other hydroxyl reactive groups (such as water or diethylene glycol). An index of 1.00 indicates a molar stoichiometric balance between isocyanate reactive groups and hydroxyl reactive groups. An index of 1.10 indicates a 10% molar excess of isocyanate reactive groups to hydroxyl reactive groups. An index of 0.85 indicates a 15% molar deficiency of isocyanate reactive groups to hydroxyl reactive groups.

The organic polyisocyanate used to the make the foams of the invention can be selected from any of those organic polyisocyanates commonly known in the art. The term organic polyisocyanate is intended to include organic di-isocyanates. Examples of suitable organic di-isocyanates and polyisocyanates include aliphatic, cycloaliphatic, arylaliphatic, aromatic and heterocyclic polyisocyanates and combinations thereof that have two or more isocyanate (NCO) groups per molecule.

Among the many organic polyisocyanates suitable for the practice of the invention are, for example, tetramethylene, hexamethylene, octamethylene and decamethylene diisocyanates, and their alkyl substituted homologs, 1,2-, 1,3- and 1,4-cyclohexane diisocyanates, 2,4- and 2,6-methyl-cyclohexane diisocyanates, 4,4′- and 2,4′-dicyclohexyl-diisocyanates, 4,4′- and 2,4′-dicyclohexylmethane diisocyanates, 1,3,5-cyclohexane triisocyanates, saturated (hydrogenated) polymethylenepolyphenylenepolyisocyanates, isocyanatomethylcyclohexaneisocyanates, isocyanatoethyl-cyclohexane isocyanates, bis(isocyanatomethyl)-cyclohexane diisocyanates, 4,4′- and 2,4′-bis(isocyanatomethyl) dicyclohexane, isophorone diisocyanate, 1,2-, 1,3-, and 1,4-phenylene diisocyanates, 2,4- and 2,6-toluene diisocyanate, 2,4′-, 4,4′- and 2,2-biphenyl diisocyanates, 2,2′-, 2,4′- and 4,4′-diphenylmethane diisocyanates, polymethylenepolyphenylene-polyisocyanates (polymeric MDI), and aromatic aliphatic isocyanates such as 1,2-, 1,3-, and 1,4-xylylene diisocyanates.

Organic isocyanates containing heteroatoms may also be utilized such as, for example, those derived from melamine. Polyisocyanates modified by carbodiimide or isocyanurate groups can also be employed. Liquid carbodiimide group- and/or isocyanurate ring-containing polyisocyanates having an isocyanate content of 15 wt % to 33.6 wt %, preferably 21 wt % to 31 wt %, are also effective, such as those based on 4,4′-, 2,4′-, and/or 2,2′-diphenylmethane diisocyanate and/or 2,4- and/or 2,6-toluene diisocyanate, and preferably 2,4- and 2,6-toluene diisocyanate and the corresponding isomer mixtures, 4,4′-, 2,4′, and 2,2′-diphenylmethane diisocyanates as well as the corresponding isomer mixtures, for example, mixtures of 4,4′- and 2,4′-diphenylmethane diisocyanates, mixtures of diphenylmethane diisocyanates and polyphenyl polymethylene polyisocyanates (polymeric MDI), and mixtures of toluene diisocyanates and polymeric MDI. Preferred, however, are the aromatic diisocyanates and polyisocyanates. Particularly preferred are 2,4′-, 2,2′- and 4,4′-diphenylmethane diisocyanate (MDI), polymethylenepolyphenylenepolyisocyanates (polymeric MDI), and mixtures of the above preferred isocyanates. Most particularly preferred are the polymeric MDIs.

Still other useful organic polyisocyanates are isocyanate terminated quasi-prepolymers. These quasi-prepolymers are prepared by reacting excess organic polyisocyanate or mixtures thereof with a minor amount of an active hydrogen-containing compound. Suitable active hydrogen containing compounds for preparing these quasi-prepolymers are those containing at least two active hydrogen-containing groups which are isocyanate reactive. Typifying such compounds are hydroxyl-containing polyesters, polyalkylene ether polyols, hydroxyl-terminated polyurethane oligomers, polyhydric polythioethers, ethylene oxide adducts of phosphorous-containing acids, polyacetals, aliphatic polyols, aliphatic thiols including alkane, alkene, and alkyne thiols having two or more SH groups, as well as mixtures thereof. Compounds which contain two or more different groups within the above-defined classes may also be used such as, for example, compounds which contain both a SH group and an OH group. Highly useful quasi-prepolymers are disclosed in U.S. Pat. No. 4,791,148 to Riley et al., the disclosure of which with respect to the quasi-prepolymers is hereby incorporated by reference.

Any suitable surfactant can be employed in the foams of this invention. Examples of suitable surfactants are compounds which serve to regulate the cell structure of the plastics by helping to control the cell size in the foam and reduce the surface tension during foaming via reaction of the aromatic polyester polyol and, optionally, other components, with an organic isocyanate as described herein. Successful results have been obtained with silicone-polyoxyalkylene block copolymers, nonionic polyoxyalkylene glycols and their derivatives, and ionic organic salts as surfactants. Examples of surfactants useful in the invention include, among others, polydimethylsiloxane-polyoxyalkylene block copolymers under the trade names DC-193 and DC-5315 (Air Products and Chemicals, Allentown, Pa.). Other suitable surfactants are organic surfactants, which are described in U.S. Pat. No. 4,751,251 to Thornsberry, including ether sulfates, fatty alcohol sulfates, sarcosinates, amine oxides, sulfonates, amides, sulfo-succinates, sulfonic acids, alkanol amides, ethoxylated fatty alcohol, and nonionics such as polyalkoxylated sorbitan. Generally, the surfactant comprises about 0.05 wt % to 10 wt %, preferably 0.1 wt % to 6 wt %, of the foam-forming composition. A preferred embodiment of the foam of the invention employs a combination of silicone-polyoxyalkylene block copolymers in minor amounts (less than 0.5 wt %) with sodium dodecylbenzene sulfonate and a polyethoxylated sorbitan monooleate (about 1.0 wt %).

As recited above, the invention further includes foams produced from the aromatic polyester polyols described herein. The foams of the invention can be made from any of the three classes of blowing agents and systems used to make polyurethane and polyisocyanurate foams which are well known in the art: the HCFC-141b blown system; a water/hydrocarbon co-blown system; and a water blown system (also referred to in the art as a carbon dioxide blown system since CO₂ is derived from the water-isocyanate reaction). Briefly, in the HCFC (141b) system, a liquid blowing agent is added to a mixture of aromatic polyester polyol, catalysts, and surfactants prior to adding a polyisocyanate. In the water blown system, water is added and mixed with an aromatic polyester polyol, catalyst, and surfactant mixture prior to adding a polyisocyanate. In the water and hydrocarbon co-blown system, both water and hydrocarbon blowing agents are added to an aromatic polyester polyol, catalyst surfactant premix prior to adding a polyisocyanate. However, in full-scale production these components may be metered directly in to the mixing head of the foam machine or premixed with a polyol stream prior to injecting into the mixing head.

Any suitable hydrogen atom-containing blowing agent can be employed to produce the foam compositions of the invention. These blowing agents, which can be used alone or as mixtures, can be selected from a broad range of materials, including partially halogenated hydrocarbons, ethers and esters, hydrocarbons, esters, ethers, and the like. Among the suitable hydrogen-containing blowing agents are the HCFCs such as 1,1-dichloro-1-fluoroethane, 1,1-dichloro-2,2,2-trifluoro-ethane, monochlorodifluoromethane, and 1-chloro-1,1-difluoroethane; the HFCs such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; the HFEs such as methyl-1,1,1-trifluoroethylether and difluoromethyl-1,1,1-trifluoroethylether; and the hydrocarbons such as n-pentane, isopentane, and cyclopentane.

A wide variety of co-blowing agents can be employed in conjunction with the hydrogen-containing agents in preparing the foam compositions of the invention. Suitable co-blowing agents include water, air, nitrogen, carbon dioxide, readily volatile organic substances, and compounds which decompose to liberate gases (e.g., azo compounds). Preferably, the blowing agent does not include a completely halogenated chlorofluorocarbon. Typical co-blowing agents have a boiling point −50° C. to 100° C., preferably from −50° C. to 50° C. In an advantageous embodiment of the invention, water and hydrocarbons are used as blowing agents in the rigid foam-forming compositions. In another preferred embodiment, water is used as the sole blowing agent.

In some embodiments, a frothing agent can be used. A frothing agent, if used, introduces a gas into the polyol. Exemplary frothing agents are carbon dioxide, air, and nitrogen. Carbon dioxide is a preferred frothing agent, and is preferably introduced into the polyol in liquid form. Liquid carbon dioxide is introduced at a temperature below the temperature at which the liquid carbon dioxide would undergo a transition to a gas, then allowed to convert to carbon dioxide gas.

The blowing agents are employed in an amount sufficient to give the resultant rigid foam the desired bulk density, generally between 0.5 and 10 pounds per cubic foot, preferably between 1 and 5 pounds per cubic foot, and most preferably between 1.5 and 2.5 pounds per cubic foot. The blowing agents generally comprise 0.5 to 30 wt %, preferably 1 to 20 wt %, of the foam forming composition. When a blowing agent has a boiling point at or below ambient temperature, the blowing agent is maintained under pressure until the blowing agent is mixed with the other components.

Other additives may also be included in the foam formulations.

These additives include processing aids, viscosity reducers, such as 1-methyl-2-pyrolidinone, propylene carbonate, nonreactive and reactive flame retardants, dispersing agents, plasticizers, mold release agents, antioxidants, compatibility agents, and fillers and pigments (e.g., carbon black and silica). The use of such additives is well known to those skilled in the art.

As recited above, the foam formulation may include flame retardants (also referred to in the art as flameproofing agents) which can be reactive or nonreactive. Examples of suitable flame retardants are tricresyl phosphate, tris(2-chloroethyl) phosphate, tris(2-chloropropyl) phosphate, and tris(2,3-dibromopropyl) phosphate. A preferred flame retardant comprises Antiblaze 80, which is a tris(chloro propyl)phosphate commercially available from Rhodia, Inc. (Cranbury, N.J.). Examples of reactive flame retardants are chlorendic acid derivatives, tetrabromophthalic anhydride and derivatives, and various phosphorous-containing polyols. In addition to the above-mentioned halogen-substituted phosphates, it is also possible to use inorganic or organic flameproofing agents, such as red phosphorus, aluminum oxide hydrate, antimony trioxide, arsenic oxide, ammonium polyphosphate and calcium sulfate, expandable graphite or cyanuric acid derivatives, e.g., melamine, or mixtures of two or more flameproofing agents, e.g., ammonium polyphosphates and melamine, and, if desired, polysaccharides such as cornstarch and flour, or ammonium polyphosphate, melamine, and expandable graphite and/or, if desired, aromatic polyesters, in order enhance the flameproofing characteristics of the resulting foam product.

In general, from 2 to 50 parts by weight, preferably from 5 to 25 parts by weight, of said flameproofing agents may be used per 100 parts by weight of the aromatic polyester polyol. A preferred embodiment of the invention comprises the use of Antiblaze 80 in combination with a polysaccharide.

The foam formulation may also include a filler, including organic and inorganic fillers and reinforcing agents. Examples of suitable fillers, which are known in the art, include inorganic fillers, such as silicate minerals, for example, phyllosilicates such as antigorite, serpentine, hornblends, amphiboles, chrysotile, and talc; metal oxides, such as kaolin, aluminum oxides, titanium oxides and iron oxides; metal salts, such as chalk, barite and inorganic pigments, such as cadmium sulfide, zinc sulfide and glass, inter alia; kaolin (china clay), aluminum silicate and co-precipitates of barium sulfate and aluminum silicate, and natural and synthetic fibrous minerals, such as wollastonite, metal, and glass fibers of various lengths. Examples of suitable organic fillers are carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and in particular, carbon fibers.

The inorganic and organic fillers may be used individually or as mixtures and may be introduced into the aromatic polyester polyol foam forming composition or isocyanate side in amounts of 0.1 wt % to 40 wt % based on the weight of the aromatic polyester polyol foam forming composition or isocyanate side.

Further details on other conventional additives (also referred to in the art as assistants) that may be used in the invention are described by J. H. Saunders and K. C. Frisch, High Polymers, Volume XVI, Polyurethanes, Parts 1 and 2, Interscience Publishers 1962 and 1964, respectively, or Kunststoff-Handbuch, Polyurethane, Volume VII, Carl-Hanser-Verlag, Munich, Vienna, 1st and 2nd Editions, 1966 and 1983.

### EXAMPLES

The following examples are provided to further illustrate the invention and are not to be construed as to unduly limit the scope of the invention. Examples 1-13 and Comparative Examples 1-4 are polyols. The “metal esterification catalyst content” reported in the polyol examples includes the residue metal esterification catalyst and glycolates, carboxylates, and other coordination compounds of the metal. Examples 14-16 provide foams prepared from the polyols of Examples 1-13 and Comparative Examples 1-4. In Examples 14-16, the parameters used to measure urethane catalytic activity were defined as follows:

Mix Time—Mixing time is the time, measured in seconds, that the foam components are actually being mixed with a mechanical agitator.

Cream Time—Cream time or initiation time is the time interval measured, in seconds, from the start of mixing of the ingredients to the visible start of the foaming reaction. The reaction begins when the mixture turns a creamy color or when the foam just begins to rise.

Gel Time—Gel time is the time, measured in seconds, from the beginning of mixing of the polyol and isocyanate components, to reach the degree of polymerization wherein a fiber or string of polymer can be drawn from the reacting mass of the polymer.

Tack-Free Time—Tack-Free time is the time interval, measured in seconds, between the start of mixing the ingredients and the time when the surface of the foam does not feel tacky to the hand or does not adhere to a wooden tongue depressor.

Rise Time—Rise time is the time interval between the start of mixing of the ingredients and the time when the foam stops rising in an open container.

### Example 1

### (Ex.1)—Aromatic Polyester Polyol Including A Non-Alkoxylated Aminoalcohol Urethane Catalytic Activity Agent

To a 2 liter reactor equipped with an agitator, 5 stage glass perforated trayed column, condenser, thermocouple, and vacuum system, was added 818 grams of diethylene glycol, 856 grams of crude terephthalic acid, and 384 grams of triethanolamine.

Next, the reaction mixture was heated over approximately 1.5 hours to 190° C. and held at that temperature for approximately 7.5 hours at atmospheric pressure. The mixture was clear after 50 minutes at 190° C. The aromatic polyester polyol had an acid number of 14.7 mg/KOH/g and a hydroxyl number of 237.2 mg/KOH/g. Next, 356 grams of diethylene glycol was added and treated under 240 mmHg of vacuum at 235-240° C. for 3 hours removing 143 grams of distillate. The acid number was reduced to 9.6 mg/KOH/g. 67 grams of diethylene glycol was then added. After 4.5 hours of vacuum at 240 mmHg, 40 grams of distillate were removed. The acid number was found to be 6.45 mg/KOH/g. This step was repeated again for 6 hours under the same reaction conditions with 30 grams of diethylene glycol added and 81 grams of distillate removed. The resulting aromatic polyester polyol had the following properties:

Hydroxyl number: 299 mg/KOH/g

Acid number: 5.1 mg/KOH/g

Viscosity: 11,288 cSt at 25° C.

Metal esterification catalyst content: none

### Example 2

### (Ex.2)—Aromatic Polyester Polyol Including Metal Esterification Catalyst Catalytic Activity Agent

To a 2 liter reactor equipped with an agitator, 5 stage glass perforated trayed column, condenser, thermocouple, and vacuum system, was added 851 grams of diethylene glycol, 770 grams of crude terephthalic acid, 325 grams of a 70% aqueous solution of sorbitol, 1.65 grams of Tyzor® PC42 (a titanate catalyst sold by E. I. du Pont de Nemours and Company, Wilmington, Del.), and 1.31 grams of antimony oxide.

Next, the reaction mixture was heated over approximately 1.5 hours to 225° C. and held at that temperature for approximately 4.5 hours when mixture cleared. Vacuum was then applied slowly pulling to approximately 220 mmHg for 5 hours removing excess diethylene glycol (21 grams) and distillate resulting in an aromatic polyester polyol having the following properties:

Hydroxyl number: 338 mg/KOH/g

Acid number: 1.75 mg/KOH/g

Viscosity: 20,637 cSt at 25° C.

Metal esterification catalyst content: about 1000 ppm antimony measured as an oxide and about 60 ppm titanate measured as an oxide

### Example 3

### (Ex.3)—Aromatic Polyester Polyol Including Metal Esterification Catalyst and Non-Alkoxylated Aminoalcohol Urethane Catalytic Activity Agents

To a 2 liter reactor equipped with an agitator, 5 stage glass perforated trayed column, condenser, thermocouple, and vacuum system, was added 902 grams of diethylene glycol, 712 grams of crude terephthalic acid, 180 grams of a 70% aqueous solution of sorbitol, 112 grams of triethanolamine column bottoms, 1.45 grams of Tyzor® PC-42, and 1.60 grams of antimony oxide.

Next, the reaction mixture was heated over approximately 1.5 hours to 210° C. and held at that temperature for approximately 2 hours at 660 mmHg when mixture cleared. The mixture was sampled for acid number resulting in an acid number of 21.6 mg/KOH/g. The temperature was then increased to 225° C. while pulling a vacuum slowly to 150 mmHg. Excess diethylene glycol (102 grams) and distillate were removed over approximately 5 hours resulting in an aromatic polyester polyol having the following properties:

Hydroxyl number: 290.4 mg/KOH/g

Acid number: 2.62 mg/KOH/g

Viscosity: 19,350 cSt at 25° C.

Metal esterification catalyst content: about 1000 ppm antimony measured as an oxide and about 60 ppm titanate measured as an oxide

### Example 4

### (Ex.4)—Aromatic Polyester Polyol Including Metal Esterification Catalyst and Non-Alkoxylated Aminoalcohol Urethane Catalytic Activity Agents

To a 2 liter reactor equipped with an agitator, 5 stage glass perforated trayed column, condenser, thermocouple, and vacuum system, was added 951 grams of diethylene glycol, 707 grams of crude terephthalic acid, 168 grams of a 70% aqueous solution of sorbitol, 127 grams of triethanolamine column bottoms, 1.43 grams of Tyzor® PC-42, and 1.58 grams of antimony oxide.

Next, the reaction mixture was heated over approximately 1.5 hours to 205° C. and held at that temperature for approximately 3.5 hours when mixture cleared. After mixture cleared, the temperature was increased to 225° C. and pulled vacuum slowly to approximately 100 mmHg. Distillate including 152 grams of excess diethylene glycol was removed over approximately 5.5 hours resulting in an aromatic polyester polyol having the following properties:

Hydroxyl number: 295 mg/KOH/g

Acid number: 2.93 mg/KOH/g

Viscosity: 18,509 cSt at 25° C.

Metal esterification catalyst content: about 1000 ppm antimony measured as an oxide and about 60 ppm titanate measured as an oxide

### Example 5

### (Ex.5)—Aromatic Polyester Polyol Including Metal Esterification Catalyst and Non-Alkoxylated Aminoalcohol Urethane Catalytic Activity Agents

To a 2 liter reactor equipped with an agitator, 5 stage glass perforated trayed column, condenser, thermocouple, and vacuum system, was added 987 grams of diethylene glycol, 733 grams of crude terephthalic acid, 173 grams of a 70% aqueous solution of sorbitol, 131.6 grams of triethanolamine column bottoms, 1.48 grams of Tyzor® PC-42, 0.47 grams of manganese acetate, and 0.82 grams of antimony oxide.

Next, the reaction mixture was heated over approximately 1.5 hours to 210° C. and held at that temperature for approximately 2.5 hours when mixture cleared. The temperature was then increased to 225° C. while pulling a vacuum slowly to approximately 110 mmHg. Excess diethylene glycol (157 grams) and distillate were removed over approximately 7.5 ours resulting in an aromatic polyester polyol having the following properties:

Hydroxyl number: 287 mg/KOH/g

Acid number: 2.86 mg/KOHIg

Viscosity: 27,363 cSt at 25° C.

Metal esterification catalyst content: about 550 ppm antimony measured as an oxide, about 270 ppm manganese measured as an oxide, and about 60 ppm titanate measured as an oxide

### Example 6

### (Ex.6)—Aromatic Polyester Polyol Including Metal Esterification Catalyst and Non-Alkoxylated Aminoalcohol Urethane Catalytic Activity Agents

To a 2 liter reactor equipped with an agitator, 5 stage glass perforated trayed column, condenser, thermocouple, and vacuum system, was added 855 grams of diethylene glycol, 754 grams of crude terephthalic acid, 177 grams of a 70% aqueous solution of sorbitol, 136 grams of triethanolamine column bottoms, 1.52 grams of Tyzor® PC-42, 0.48 grams of manganese acetate, and 0.82 grams of antimony oxide.

Next, the reaction mixture was heated over approximately 1.5 hours to 195° C. and held at that temperature for approximately 3 hours when mixture cleared. After mixture cleared, the temperature was increased to 220° C. while pulling a vacuum slowly to approximately 100 mmHg. Distillate including 56 grams over theoretical water was removed over approximately 7.5 hours resulting in an aromatic polyester polyol having the following properties:

Hydroxyl number: 246 mg/KOH/g

Acid number: 2.61 mg/KOH/g

Viscosity: 31,524.5 cSt at 25° C.

Metal esterification catalyst content: about 550 ppm antimony measured as an oxide, about 270 ppm manganese measured as an oxide, and about 60 ppm titanate measured as an oxide

### Example 7

### (Ex.7)—Aromatic Polyester Polyol Including Metal Esterification Catalyst and Non-Alkoxylated Aminoalcohol Urethane Catalytic Activity Agents

To a 2 liter reactor equipped with an agitator, 5 stage glass perforated trayed column, condenser, thermocouple, and vacuum system, was added 753 grams of diethylene glycol, 753 grams of low molecular weight (about 8-10,000 MW) polyethylene terephthalate (having an inherent viscosity of 0.25 dl/g, 275 ppm antimony, 2.0% w/w isophthalic acid, 20 ppm phosphorus, 1.7% w/w diethylene glycol, and 5 ppm organic toner), 169 grams of a 70% aqueous solution of sorbitol, 109 grams of triethanolamine column bottoms, and 1.52 grams of Tyzor® PC42.

Next, the reaction mixture was heated over approximately 1.5 hours to 235° C. and held at that temperature for approximately 4 hours. Vacuum was then pulled to approximately 360 mmHg with the reaction continuing for approximately another 4 hours. Ethylene glycol distillate was removed during both steps resulting in an aromatic polyester polyol having the following properties:

Hydroxyl number: 347.9 mg/KOH/g

Acid number: 1.5 mg/KOH/g

Viscosity: 4,700 cSt at 25° C.

Metal esterification catalyst content: about 350 ppm antimony measured as an oxide and about 60 ppm titanate measured as an oxide

### Example 8

### (Ex.8)—Aromatic Polyester Polyol Including Metal Esterification Catalyst Urethane Catalytic Activity Agent

To a 2 liter reactor equipped with an agitator, 5 stage glass perforated trayed column, condenser, thermocouple, and vacuum system, was added 901 grams of diethylene glycol, 743 grams of crude terephthalic acid, 312 grams of a 70% aqueous solution of sorbitol, and 1.8 grams of Tyzor® PC-42.

Next, the reaction mixture was heated over approximately 1.5 hours to 225° C. and held at that temperature for approximately 5 hours when mixture cleared. Vacuum was then applied slowly pulling to approximately 200 mmHg for 3 hours removing 71 grams of excess diethylene glycol and distillate resulting in an aromatic polyester polyol having the following properties:

Hydroxyl number: 370 mg/KOH/g

Acid number: 2.3 mg/KOH/g

Viscosity: 7,088 cSt at 25° C.

Metal esterification catalyst content: about 60 ppm titanate measured as an oxide

### Example 9

### (Ex.9)—Aromatic Polyester Polyol Including Non-Alkoxylated Aminoalcohol Urethane Catalytic Activity Agent

To a 2 liter reactor equipped with an agitator, 5 stage glass perforated trayed column, condenser, thermocouple, and vacuum system, was added 892 grams of diethylene glycol, 693 grams of crude terephthalic acid, 163 grams of a 70% aqueous sorbitol solution, and 125 grams of triethanolamine column bottoms.

Next, the reaction mixture was heated over approximately 1.5 hours to 225° C. and held at that temperature for approximately 2.5 hours at atmospheric pressure. After approximately 3.5 hours of vacuum at 200 mmHg, 320 grams of total distillate (including 106 grams of excess diethylene glycol) was removed. The resulting aromatic polyester polyol had the following properties:

Hydroxyl number: 267 mg/KOH/g

Acid Number: 1.83 mg/KOH/g

Viscosity: 24,975 cSt at 25° C.

Metal esterification catalyst content: about 60 ppm titanate measured as an oxide

### Example 10

### (Ex.10)—Aromatic Polyester Polyol Including Metal Esterification Catalyst Urethane Catalytic Activity Agent

To a 2 liter reactor equipped with an agitator, 5 stage glass perforated trayed column, condenser, thermocouple, and vacuum system, was added 890 grams of diethylene glycol, 696 grams of crude terephthalic acid, 283 grams of a 70% aqueous sorbitol solution, and 28.2 grams of Tyzor® PC-42.

Next, the reaction mixture was heated over 1.5 hours to 225° C. and held at that temperature for approximately 6 hours at atmospheric pressure. Vacuum was then applied slowly pulling to approximately 220 mmHg for 7 hours removing 90 grams of excess diethylene glycol and distillate resulting in an aromatic polyester polyol having the following properties:

Hydroxyl number: 384.7 mg/KOH/g

Acid number: 1.47 mg/KOH/g

Viscosity: 5,563 cSt at 25° C.

Metal esterification catalyst content: about 1200 ppm titanate measured as an oxide

### Example 11

### (Ex.11)—Aromatic Polyester Polyol Including Metal Esterification Catalyst Urethane Catalytic Activity Agent

To a 2 liter reactor equipped with an agitator, 5 stage glass perforated trayed column, condenser, thermocouple, and vacuum system, was added 387 grams of diethylene glycol, 1130 grams of ethylene glycol recovery bottoms obtained from DuPont SA Adana DMT plant having a saponification value of approximately 400, a hydroxyl value (OH) of 540, an acid number (AN) of 3.2, and free glycol content less than 20% by wt. of the ethylene glycol recovery bottoms, 274 grams of a 70% aqueous solution of sorbitol, and 1.42 grams of Tyzor PC42.

Next, the reaction mixture was heated over approximately 1.5 hours to 230° C. for approximately 8 hours. Vacuum was then applied slowly pulling to approximately 450 mmHg for 1.5 hours resulting in a total distillate of 497 grams and a reaction mass resulting in an aromatic polyester polyol having the following properties:

Hydroxyl number: 407.9

Acid number: 2.26

Viscosity: 22,465 cSt at 25° C.

Metal esterification catalyst content: 6450 ppm of antimony measured as an oxide

### Example 12

### Aromatic Polyester Polyol Including Non-Alkoxylated Aminoalcohol Urethane Catalytic Activity Agent

To a 2 liter reactor equipped with an agitator, 5 stage glass perforated trayed column, thermocouple, condenser, and vacuum system was added 600 grams of diethylene glycol, 944 grams of low molecular weight (about 8-10,000 MW) polyethylene terephthalate (having an inherent viscosity of 0.25 dl/g, 275 ppm antimony, 2.0% w/w isophthalic acid, 20 ppm phosphorus, 1.7% w/w diethylene glycol, and 5ppm organic toner) of polyethylene terephthalate resin (DuPont NG-3), 192 g of a 70% aqueous sorbitol solution, 147 grams of triethanolamine column bottoms, and 1.5 grams of Tyzor® PC42.

The mixture was heated up to 230° C. over approximately 2 hours, and stirred at that temperature for approximately 2 hours at atmospheric pressure. Vacuum was then applied slowly pulling to approximately 410 mmHg for 2.5 hours resulting in a total distillate of 356 grams. The resulting aromatic polyester polyol had the following properties:

Hydroxyl number: 321 mg KOH/g

Acid number: 2.51 mg KOH/g

Viscosity: 12,793 cSt at 25° C.

Metal esterification catalyst content: about 120 ppm of Ti measured as an oxide

### Example 13

### Aromatic Polyester Polyol Including Metal Esterification Catalyst Urethane Catalytic Activity Agent

To a 3 liter reactor equipped with an agitator, 5 stage glass perforated trayed column, thermocouple, condenser, and vacuum system was added 721 grams of diethylene glycol, 1105 grams of low molecular weight (about 8-10,000 MW) polyethylene terephthalate (having an inherent viscosity of 0.25 dl/g, 275 ppm antimony, 2.0% w/w isophthalic acid, 20 ppm phosphorus, 1.7% w/w diethylene glycol, and 5ppm organic toner) of polyethylene terephthalate resin (DuPont NG-3), 389 g of a 70% aqueous sorbitol solution and 1.8 grams of Tyzor® PC-42.

The mixture was heated up to 230° C. over approximately 2.5 hours, and stirred at that temperature for approximately 5 hours at atmospheric pressure. Vacuum was then pulled slowly pulling to approximately 430 mmHg for 2.5 hours resulting in a total distillate of 316 grams. The resulting aromatic polyester polyol had the following properties:

Hydroxyl number: 402 mg KOH/g

Acid number: 1.26 mg KOH/g

Viscosity: 18,605 cSt at 25° C.

Metal esterification catalyst content: about 350 ppm antimony measured as an oxide; about 150 ppm manganese as measured as an oxide; and about 60 ppm titanate measured as an oxide

### Comparative Example 1

### (CE1)—Aromatic Polyester Polyol Without Any Urethane Catalytic Activity Agent

To a 2 liter reactor equipped with an agitator, 5 stage glass perforated trayed column, condenser, thermocouple, and vacuum system, was added 1040 grams of diethylene glycol, 850 grams of crude terephthalic acid, and 346 grams of a 70% aqueous sorbitol solution.

Next, the reaction mixture was heated over approximately 1.5 hours to 230° C. and held at that temperature for approximately 8.5 hours when mixture was cleared. Vacuum was then applied slowly pulling to approximately 220 mmHg for 7.5 hours removing 95 grams of excess diethylene glycol and distillate resulting in an aromatic polyester polyol having the following properties:

Hydroxyl number: 334.8 mg/KOH/g

Acid number: 1.9 mg/KOH/g

Viscosity: 16,539 cSt at 25° C.

Metal esterification catalyst content: None

### Comparative Example 2

### (CE2)—Aromatic Polyester Polyol from U.S. Pat. No. 4,442,237 to Zimmerman et al.

The polyol of CE2 was prepared in the manner as described in Example II of U.S. Pat. No. 4,442,237 to Zimmerman et al., with the exception that the polyethylene terephthalate still bottoms were obtained from a glycol recovery unit having an hydroxyl number of 227 mg/KOH/g instead of the hydroxyl number of 169 mg/KOH/g used in U.S. Pat. No. 4,442,237. In a one liter three-necked flash equipped with a mechanical stirrer, thermocouple, and distillation head was placed 300 grams of polyethylene terephthalate still bottoms, 156.2 grams of diethylene glycol, 73.1 grams of triethanolamine, 10 grams of water, and 15 grams of magnesium silicate. The mixture was heated to 240° C. and held for six hours. The material left in the pot was filtered. The resulting aromatic polyester polyol had the following properties:

Hydroxyl number: 403.1 mg/KOH/g

Acid number: 3.69 mg/KOH/g

Viscosity: 775 cSt at 25° C.

Metal esterification catalyst content: approximately 3000 ppm antimony measured as an oxide

### Comparative Example 3

### (CE3)—Terol® 352 Polyol

Terol® 352 was obtained from the manufacturer (Oxid L.P., Houston, Tex.) and had an acid number of 2.57 mg/KOH/g and a hydroxyl number of 364 mg/KOH/g.

### Comparative Example 4

### (CE4)—Terate® 203 Polyol

Terate® 203 was obtained from the manufacturer (KoSa, Wilmington, N.C.) and had an acid number of 2.66 mg/KOH/g and a hydroxyl number of 326 mg/KOH/g.

### Example 14

### Polyurethane Foam Made Using HCFC-141b System

Rigid polyurethane foams were prepared using the one-shot technique. Specifically, all of the ingredients (which are provided below in Table 1) except the isocyanate were mixed together and then the isocyanate was added. The final mixture was then stirred using a 2200 rpm stirrer outfitted with a 2″ conn blade for the indicated time and then poured into a 2100 ml open mold, plastic cup. Within a few seconds, the liquid mix in the cup changed color from a dark to a light brown. This color change was an indication of the foam starting to react and bubbles being formed by the blowing agent in the foam forming mixture. As defined above, the time in seconds from start of mixing was recorded as the cream time. The foaming mixture continued to rise up within the cup. A sharpened piece of wood or similar device was submerged in the foaming mass and withdrawn. This was repeated until a fibrous strand was seen emerging from the foam. As defined above, this was referred to as the gel time and was recorded in seconds elapsed since the mixing began. The foam was next visually observed and the surface was contacted by a dry wooded spatula. The rise time and tack-free time as defined above were also recorded. The formulations employed and the results obtained are set forth in Table 1.

TABLE 1
Inherent Catalytic Activity of Polyols in HCFC-141B System

| Polyol | Ex.1 | Ex.2 | Ex.3 | Ex.8 | Ex.9 | Ex.10 | CE1 | CE2 | CE3 | CE3 | CE4 |
|---|---|---|---|---|---|---|---|---|---|---|---|
| Polyol amount | 44.15 | 41.68 | 40.13 | 39.79 | 46.21 | 37.23 | 40.25 | 37.10 | 42.54 | 40.60 | 42.38 |
| HCFC-141b | 12.80 | 12.86 | 12.64 | 12.73 | 12.48 | 12.66 | 12.34 | 12.80 | 17.02 | 12.79 | 12.71 |
| Water (wt %) | 0.41 | 0.42 | 0.40 | 0.44 | 0.44 | 0.45 | 0.42 | 0.41 | — | 0.43 | 0.42 |
| Surfactant | 1.06 | 1.04 | 1.00 | 1.03 | 1.03 | 1.02 | 0.97 | 1.04 | 1.06 | 1.01 | 1.06 |
| “B side” total | 58.43 | 56.00 | 54.18 | 54.00 | 60.15 | 51.36 | 54.18 | 51.34 | 60.62 | 54.83 | 56.58 |
| Polymeric MDI⁽²⁾ | 41.57 | 44.00 | 45.82 | 46.00 | 39.85 | 48.64 | 45.82 | 48.66 | 39.38 | 45.17 | 43.42 |
| Ingredient total | 100 | 100 | 100 | 100 | 100 | 100 | 100 | 100 | 100 | 100 | 100 |
| NCO Index | 1.10 | 1.10 | 1.35 | 1.10 | 1.10 | 1.18 | 1.18 | 1.16 | 1.06 | 1.08 | 1.10 |
| Foaming Mix Time (sec.) | 10 | 15 | 15 | 15 | 15 | 15 | 15 | 8 | 15 | 15 | 15 |
| Foaming Cream Time (sec.) | 13 | 140 | 27 | 530 | 34 | 320 | 525 | 9 | 328 | 250 | 185 |
| Foaming Gel Time (sec.) | 37 | 260 | 69 | 1625 | 94 | 1040 | 1525 | 20 | >1200 | 750 | 417 |
| Foaming Rise Time (sec.) | 47 | 450 | 90 | >1800 | 195 | >1800 | >1800 | 35 | >1200 | >900 | 680 |
| Foaming Tack-Free Time | 50 | 660 | 110 | >1800 | 152 | >1800 | >1800 | 30 | >1200 | >900 | >900 |
| Foam Density (kg/m³) | 30.9 | 28.8 | 24.2 | — | 26.1 | 43.1 | — | 22.9 | — | 33.5 | 29.9 |
| Foam Remarks | (a) | (b) | (c) | (d) | (e) | (f) | (g) | (h) | (i) | (j) | (k) |

⁽¹⁾Air Products DC-193 silicone surfactant (Air Products and Chemicals, Inc., Allentown, Pennsylvania)
⁽²⁾Dow Polymeric MDI 580N (The Dow Chemical Co., Midland, Michigan)
⁽³⁾Reaction was so fast that the quick pour method of MDI was required. The quick pour method uses a preweighed quantity of MDI which can be added to the premixed foamable mixture (consisting of polyol, blowing agent, catalyst and surfactant) in less than one second instead of typically more than 10 seconds when adding the MDI to an exact weight on the balance. This technique allows for a short mixing time before cream time is reached for very fast systems.
Foam Remarks:
(a) considerable shrinkage from cup wall (est. >15% volumetric); considerable cutting (>50% volume) to get to dense closed cell core
(b) significant shrinkage from cup wall (10-15%); friable; considerable cutting (>50% volume) to get to foam core
(c) fine closed cell foam; no distortion first week after cutting
(d) dense friable mass
(e) fine closed cell foam; no distortion 24 hrs after cutting
(f) open cell foam; very friable
(g) dense friable mass
(h) fine closed cell foam; no distortion first 24 hrs after cutting
(i) foam collapsed
(j) foam is open celled; considerable cutting (>50% volume) to get to hard dense core
(k) very friable; significant shrinkage from cup wall (est. >15% volumetric); open celled; considerable cutting (>50% volume) to get to dense core

As shown in Table 1, the CE1 polyol (which did not contain a metal esterification catalyst or non-alkoxylated aminoalcohol) had a foaming gel time of 1525 seconds. The aromatic polyester polyols of the invention that included a non-alkoxylated aminoalcohol urethane catalytic activity agent had foaming gel times of 37 seconds (Ex.1) and 94 seconds (Ex.9). Thus, the polyurethane foam reaction polymerization rates of the Ex.1 and Ex.9 polyols were increased by 2426% and 616%, respectively, as compared to the CE1 polyol.

The aromatic polyester polyols of the invention that included a metal esterification catalyst urethane catalytic activity agent had foaming gel times of 260 seconds (Ex.2), 1625 seconds (Ex.8), and 1040 seconds (Ex.10). The polyurethane foam reaction polymerization rates of the Ex.2 and Ex.10 polyols were increased by 170% and 68%, respectively, as compared to the CE1 polyol which did not contain a urethane catalytic activity agent. However, the Ex.8 polyol, which contained 1.52 grams of titanate, achieved a foaming gel time (1625 seconds) greater than the foaming gel time of the CE1 polyol. Comparing the foaming gel times of the Ex.8 and Ex.10 polyols, it should be apparent that increasing the amount of titanate, which is a poor urethane catalytic activity agent, improves the foaming gel time and, thus, the polyurethane foam reaction polymerization rate, of the polyol. The Ex.10 polyol contained 1200 ppm of titanate (28.2 grams of Tyzor® PC-42) and achieved an improved foaming gel time as compared to the Ex.8 polyol containing only 60 ppm of titanate (1.52 grams of Tyzor® PC-42).

Lastly, the aromatic polyester polyol of the invention that included both non-alkoxylated aminoalcohol and metal esterification catalyst urethane catalytic activity agents had a foaming gel time of 69 seconds (Ex.3) and, thus, achieved a polyurethane foam reaction polyurethane rate increase of 452% as compared to the CE1 polyol.

The CE2, CE3, and CE4 polyols achieved foaming gel times of 20 seconds, 1200 seconds (without water) and 750 seconds (with water), and 417 seconds and, thus, achieved polyurethane foam reaction polymerization rate increases of 7625%, 127%, 203%, and 366% as compared to CE1.

These results demonstrate the greatly enhanced polyurethane foam reaction polymerization rates achieved by the aromatic polyester polyols of the invention due to the presence of at least one urethane catalytic activity agent.

### Example 15

### Polyurethane Foam Made Using Water/HC Co-Blow System

Rigid polyurethane foams were prepared using the one-shot technique. Specifically, all of the ingredients (which are provided below in Table 2) except the isocyanate were mixed together and then the isocyanate was added. The final mixture was then stirred using a 2200 rpm stirrer ouffitted with a 2″ conn blade for the indicated time and then poured into a 2100 ml open mold, plastic cup. Within a few seconds, the liquid mix in the cup changed color from a dark to a light brown. This color change was an indication of the foam starting to react and bubbles being formed by the blowing agent in the foam forming mixture. As defined above, the time in seconds from start of mixing was recorded as the cream time. The foaming mixture continued to rise up within the cup. A sharpened piece of wood or similar device was submerged in the foaming mass and withdrawn. This was repeated until a fibrous strand was seen emerging from the foam. As defined above, this was referred to as the gel time and was recorded in seconds elapsed since the mixing began. The foam was next visually observed and the surface was contacted by a dry wooded spatula. The rise time and tack-free time as defined above were also recorded. The formulations employed and the results are set forth in Table 2.

TABLE 2
Inherent Catalytic Activity of Polyols in Water/HC Co-Blow System

| Polyol | Ex.2 | Ex.4 | Ex.5 | Ex.6 | Ex.6 | Ex.7 | Ex.7 | Ex.10 | Ex.12 | Ex.13 | CE1 | CE3 | CE4 |
|---|---|---|---|---|---|---|---|---|---|---|---|---|---|
| Polyol amount | 32.69 | 33.58 | 33.98 | 36.55 | 36.86 | 32.29 | 32.95 | 31.22 | 35.59 | 33.62 | 33.1 | 32.81 | 32.77 |
| (wt %) | | | | | | | | | | | | | |
| HC⁽¹⁾ (wt %) | 5.23 | 5.04 | 5.35 | 5.67 | 5.34 | 5.17 | 5.27 | 5.23 | 4.63 | 4.37 | 5.30 | 5.25 | 5.25 |
| Water (wt %) | 0.54 | 0.53 | 0.54 | 0.58 | 0.59 | 0.57 | 0.54 | 0.53 | 0.61 | 0.57 | 0.53 | 0.54 | 0.54 |
| Urethane | — | — | — | 0.18 | — | 0.19 | — | — | — | — | — | — | — |
| Catalyst⁽²⁾ | | | | | | | | | | | | | |
| (wt %) | | | | | | | | | | | | | |
| Additives | 8.50 | 8.40 | 8.49 | 8.41 | 8.48 | 8.07 | 8.24 | 8.12 | 8.90 | 8.30 | 8.28 | 8.20 | 8.20 |
| Mixture⁽³⁾ | | | | | | | | | | | | | |
| (wt % | | | | | | | | | | | | | |
| “B side” total | 46.95 | 47.54 | 48.37 | 51.39 | 51.27 | 46.28 | 47.00 | 45.08 | 49.72 | 46.97 | 47.20 | 46.80 | 46.79 |
| Polymeric | 53.05 | 52.46 | 51.63 | 48.61 | 48.73 | 53.72 | 53.00 | 54.92 | 50.28 | 53.03 | 52.80 | 53.20 | 53.21 |
| MDI⁽⁴⁾ (wt %) | | | | | | | | | | | | | |
| Ingredient total | 100 | 100 | 100 | 100 | 100 | 100 | 100 | 100 | 100 | 100 | 100 | 100 | 100 |
| NCO Index | 1.12 | 1.18 | 1.09 | 1.12 | 1.12 | 1.12 | 1.10 | 1.12 | 1.10 | 1.10 | 1.12 | 1.08 | 1.15 |
| Foaming Mix | 15 | 15 | 15 | 15 | 15 | 10 | 13 | 15 | 15 | 20 | 15 | 15 | 15 |
| Time (sec.) | | | | | | | | | | | | | |
| Foaming | 65 | 28 | 38 | 16 | 21 | 14 | 13 | 170 | 16 | 127 | 230 | 120 | 1700 |
| Cream Time | | | | | | | | | | | | | |
| (sec.) | | | | | | | | | | | | | |
| Foaming Gel | 300 | 95 | 160 | 50 | 73 | 43 | 57 | 990 | 60 | 851 | 1770 | 690 | 602 |
| Time (sec.) | | | | | | | | | | | | | |
| Foaming Rise | 565 | 175 | 380 | 108 | 175 | 72 | 110 | >1800 | 122 | >1800 | >1800 | 988 | 870 |
| Time (sec.) | | | | | | | | | | | | | |
| Foaming | >900 | 146 | 310 | 85 | 153 | 60 | 82 | >1800 | 88 | 1342 | >1800 | >12 | >1200 |
| Tack-Free | | | | | | | | | | | | | |
| Time (sec.) | | | | | | | | | | | | | |
| Foam Density | 30.8 | 25.2 | 25.1 | 23.6 | 23.9 | 24.2 | 24.5 | — | 26.0 | 34.2 | — | 40.3 | 42.3 |
| (kg/m³) | | | | | | | | | | | | | |
| Foam Remarks | (a) | (b) | (c) | (d) | (e) | (f) | (g) | (h) | (i) | (j) | (k) | (l) | (m) |

⁽¹⁾50/50 iso/cyclo pentane mix
⁽²⁾Air Products Dabco 33LV (Air Products and Chemicals, Inc., Allentown, Pennsylvania)
⁽³⁾Additives mixture with 41.3% organic filler, 40% Tris 2-chloropropylphosphate (TCPP), 12% Air Products DC-193, and 6.7% water by weight
⁽⁴⁾Dow Polymeric MDI 580N
Foam Remarks:
(a) very friable, significant shrinkage from cup wall (10-15%), closed cell
(b) non friable, closed cell foam, no shrinkage 24 hours after cutting
(c) non friable, closed cell foam, no shrinkage 24 hours after cutting
(d) non friable, closed cell foam, no shrinkage 24 hours after cutting
(e) non friable, closed cell foam, no shrinkage 24 hours after cutting
(f) non friable, closed cell foam, no shrinkage 24 hours after cutting
(g) non friable, closed cell foam, no shrinkage 24 hours after cutting
(h) dense friable mass
(i) non friable, closed cell foam, no shrinkage 24 hours after cutting
(j) very friable surface, core foam non friable, closed cell foam, no shrinkage 24 hours after cutting
(k) dense friable mass
(l) very friable, severe shrinkage from cup wall (>15%), open cell foam
(m) very friable, significant shrinkage from cup wall (10-15%), closed cell foam

As shown in Table 2, the CE1 polyol, which did not contain a metal esterification catalyst or non-alkoxylated aminoalcohol, had a foaming gel time of 1770 seconds. The aromatic polyester polyols of the invention that included a metal esterification catalyst urethane catalytic activity agent had foaming gel times of 300 seconds (Ex.2), 990 seconds (Ex.10), and 851 seconds (Ex. 13). Thus, the polyurethane foam reaction polymerization rates of the Ex.2 and Ex.1 0 polyols were increased by 590%, 179%, and 208% respectively, as compared to the CE1 polyol which did not contain a urethane catalytic activity agent.

The aromatic polyester polyols of the invention that included both non-alkoxylated aminoalcohol and metal esterification catalyst urethane catalytic activity agents had foaming gel times of 95 seconds (Ex.4), 160 seconds (Ex.5), 73 seconds (Ex.6), and 57 seconds (Ex.7), and 60 seconds (Ex. 12) and, thus, achieved polyurethane foam reaction polyurethane rate increases of 1863%, 1106%, 2425%, 3105%, and 2950% as compared to the CEI polyol.

To determine the effect of a conventional urethane catalyst on foams made using the aromatic polyester polyols of the invention, foams were produced using the Ex.6 and Ex.7 polyols with Air Products Dabco 33LV, a conventional urethane catalyst. As shown in Table 2, the foaming gel time of the Ex.6 polyol changed from 73 seconds to 50 seconds when the urethane catalyst was added. The foaming gel time of the foam made with the Ex.7 polyol changed from 57 seconds to 43 seconds with the addition of the urethane catalyst.

The CE3 and CE4 polyols achieved foaming gel times of 690 seconds and 602 seconds and, thus, achieved polyurethane foam reaction polymerization rate increases of 257% and 294% as compared to CE1.

These results demonstrate the greatly enhanced polyurethane foam reaction polymerization rates achieved by the aromatic polyester polyols of the invention due to the presence of the urethane catalytic activity agent.

### Example 16

### Polyurethane Foam Made Using Water Blow System

Rigid polyurethane foams were prepared using the one-shot technique. Specifically, all of the ingredients (which are provided below in Table 3) except the isocyanate were mixed together and then the isocyanate was added. The final mixture was then stirred using a 2200 rpm stirrer ouffitted with a 2″ conn blade for the indicated time and then poured into a 2100 ml open mold, plastic cup. Within a few seconds, the liquid mix in the cup changed color from a dark to a light brown. This color change was an indication of the foam starting to react and bubbles being formed by the blowing agent in the foam forming mixture. As defined above, the time in seconds from start of mixing was recorded as the cream time. The foaming mixture continued to rise up within the cup. A sharpened piece of wood or similar device was submerged in the foaming mass and withdrawn. This was repeated until a fibrous strand was seen emerging from the foam. As defined above, this was referred to as the gel time and was recorded in seconds elapsed since the mixing began. The foam was next visually observed and the surface was contacted by a dry wooded spatula. The rise time and tack-free time as defined above were also recorded. The formulations employed and the results are set forth in Table 3.

TABLE 3
Inherent Catalytic Activity of Polyols in Water Blow System

| Polyol | Ex.2 | Ex.5 | Ex.7 | Ex.11 | CE1 | CE3 | CE4 |
|---|---|---|---|---|---|---|---|
| Polyol amount (wt %) | 28.98 | 30.90 | 28.78 | 27.58 | 29.05 | 28.44 | 30.61 |
| Water (wt %) | 1.42 | 1.45 | 1.41 | 1.35 | 1.42 | 1.39 | 1.5 |
| Urethane Catalyst | — | — | — | — | — | — | — |
| Additives Mixture⁽¹⁾ (wt %) | 8.70 | 8.65 | 8.63 | 8.27 | 8.71 | 8.53 | 9.18 |
| “B side” total | 39.10 | 41.00 | 38.82 | 37.20 | 39.19 | 38.37 | 41.29 |
| Polymeric MDI⁽²⁾ (wt %) | 60.90 | 59.00 | 61.18 | 62.80 | 60.81 | 61.63 | 58.71 |
| Ingredient total | 100 | 100 | 100 | 100 | 100 | 100 | 100 |
| NCO Index | 1.05 | 1.05 | 1.05 | 1.05 | 1.05 | 1.05 | 1.05 |
| Foaming Mix Time (sec.) | 15 | 10 | 15 | 15 | 15 | 15 | 15 |
| Foaming Cream Time (sec.) | 104 | 10 | 16 | 43 | 110 | 80 | 91 |
| Foaming Gel Time (sec.) | 330 | 59 | 64 | 130 | 290 | 290 | 290 |
| Foaming Rise Time (sec.) | 550 | 104 | 91 | 270 | 540 | 720 | 555 |
| Foaming Tack-Free Time | 530 | 84 | 81 | 170 | 940 | 720 | 555 |
| (sec.) | | | | | | | |
| Foam Density, (kg/m³) | 37.2 | 31.9 | 30.2 | 31.8 | 45.0 | 37.2 | 39.7 |
| Foam Remarks | (a) | (b) | (c) | (d) | (e) | (f) | (g) |

⁽¹⁾Additives mixture with 41.3% organic filler, 40% TCPP, 12% Air Products DC-193, and 6.7% water by weight
⁽²⁾Dow Polymeric MDI 580N
Foam Remarks:
(a) dense, tough open cell foam, no shrinkage 24 hours after cutting
(b) non friable, fine closed cells, no shrinkage 24 hours after cutting
(c) non friable, fine closed cells, no shrinkage 24 hours after cutting
(d) friable skin, closed cell foam inside, slight shrinkage on cooling; no shrinkage 24 hours after cutting
(e) dense, tough open cell foam, no shrinkage 24 hours after cutting
(f) dense, tough open cell foam, no shrinkage 24 hours after cutting
(g) dense, tough open cell foam, no shrinkage 24 hours after cutting

As shown in Table 3, the CE1 polyol, which did not contain a metal esterification catalyst or non-alkoxylated aminoalcohol, had a foaming gel time of 290 seconds. The aromatic polyester polyols of the invention that included a metal esterification catalyst urethane catalytic activity agent had foaming gel times of 330 seconds (Ex.2) and 130 seconds (Ex. 11). Thus, the polyurethane foam reaction polymerization rate of the Ex.2 polyol increased (330 seconds) compared to CE1 (290 seconds). The increase of the Ex. 2 polyol polyurethane foam reaction polymerization rate as compared to the CE1 polyol polyurethane foam reaction polymerization rate can be attributed to experimental error, since it is difficult to assess the foaming gel time end for polyols having poor polyurethane foam reaction polymerization rates. The polyurethane foam reaction polymerization rate of the Ex. 11 polyol increased by 223% as compared to the CE1 polyol. The improved Ex.11 polyol polyurethane foam reaction polymerization rate as compared to the Ex.2 polyol polyurethane foam reaction polymerization rate can be attributed to the increased metal esterification catalyst content of the Ex.11 polyol.

The aromatic polyester polyols of the invention that included both non-alkoxylated aminoalcohol and metal esterification catalyst urethane catalytic activity agents had foaming gel times of 59 seconds (Ex.5) and 64 seconds (Ex.7) and, thus, achieved polyurethane foam reaction polymerization rate increases of 492% and 453% as compared to the CE1 polyol.

The CE3 and CE4 polyols achieved identical foaming gel times to that of the CE1 polyol. Thus, the CE3 and CE4 polyols did not achieve any increase in the polyurethane foam reaction polymerization rate.

These results demonstrate the greatly enhanced polyurethane foam reaction polymerization rates achieved by the aromatic polyester polyols of the invention due to the presence of the urethane catalytic activity agent.

It is to be understood that the above-described embodiments are illustrative only and that modification throughout may occur to one skilled in the art. Accordingly, this invention is not to be regarded as limited to the embodiments disclosed herein.

What is claimed is:

1. An aromatic polyester polyol having an acid number below 3.0 mg/KOH/g, wherein said aromatic polyester polyol is the reaction product of a reaction mixture comprising:
(a) an acid component;
(b) a glycol component; and
(c) a urethane catalytic activity agent that comprises a non-alkoxylated aminoalcohol.

2. The aromatic polyester polyol of claim 1 that has an average hydroxyl functionality less than 4.0.

3. The aromatic polyester polyol of claim 1 that has a polyurethane foam reaction polymerization rate that is increased by at least 50% by the presence of said urethane catalytic activity agent.

4. The aromatic polyester polyol of claim 1 wherein said non-alkoxylated aminoalcohol is a non-alkoxylated tertiary aminoalcohol.

5. The aromatic polyester polyol of claim 1 wherein said urethane catalytic activity agent further comprises a metal esterification catalyst.

6. A blend comprising (i) one or more blowing agents, surfactants, catalysts, or a combination thereof and (ii) the aromatic polyester polyol of claim 1.

7. A polyisocyanurate foam prepared from the aromatic polyester polyol of claim 1.

8. A polyurethane foam prepared from the aromatic polyester polyol of claim 1.

9. An aromatic polyester polyol having an acid number below 3.0 mg/KOH/g, wherein said aromatic polyester polyol is the reaction product of a reaction mixture comprising:
(a) an acid component;
(b) a glycol component; and
(c) a urethane catalytic activity agent comprising at least one of a non-alkoxylated aminoalcohol and a metal esterification catalyst,
wherein:
(i) said aromatic polyester polyol has a polyurethane foam reaction polymerization rate in an HCFC-141b blown system that is increased at least 367% by the presence of said urethane catalytic activity agent;
(ii) said aromatic polyester polyol has a polyurethane foam reaction polymerization rate in a water/hydrocarbon co-blown system that is increased at least 295% by the presence of said urethane catalytic activity agent; or
(iii) said aromatic polyester polyol has a polyurethane foam reaction polymerization rate in a water blown system that is increased by the presence of said urethane catalytic activity agent.

10. The aromatic polyester polyol of claim 9 wherein said polyurethane foam reaction polymerization rate is increased at least 400% by the presence of said urethane catalytic activity agent.

11. The aromatic polyester polyol of claim 9 wherein said urethane catalytic activity agent comprises said non-alkoxylated aminoalcohol and said metal esterification catalyst.

12. The aromatic polyester polyol of claim 9 that has an average hydroxyl functionality of at least 2.0.

13. A blend comprising (i) one or more blowing agents, surfactants, catalysts, or a combination thereof and (ii) the aromatic polyester polyol of claim 9.

14. A polyisocyanurate foam prepared from the aromatic polyester polyol of claim 9.

15. A polyurethane foam prepared from the aromatic polyester polyol of claim 9.

16. A process for producing an aromatic polyester polyol having an acid number below 3.0 mg/KOH/g, comprising reacting, at a temperature greater than 150° C., a reaction mixture comprising:
(a) an acid component;
(b) a glycol component; and
(c) a urethane catalytic activity agent that comprises a non-alkoxylated aminoalcohol.

17. A process for producing an aromatic polyester polyol having an acid number below 3.0 mg/KOH/g, comprising reacting, at a temperature greater than 150° C., a reaction mixture comprising:
(a) an acid component;
(b) a glycol component; and
(c) an urethane catalytic activity agent comprising at least one of a non-alkoxylated aminoalcohol and a metal esterification catalyst,
wherein:
(i) said aromatic polyester polyol has a polyurethane foam reaction polymerization rate in an HCFC-141b blown system that is increased at least 367% by the presence of said urethane catalytic activity agent;
(ii) said aromatic polyester polyol has a polyurethane foam reaction polymerization rate in a water/hydrocarbon co-blown system that is increased at least 295% by the presence of said urethane catalytic activity agent; or
(iii) said aromatic polyester polyol has a polyurethane foam reaction polymerization rate in a water blown system that is increased by the presence of said urethane catalytic activity agent.

18. The process of claim 16 or 17 wherein said acid component comprises at least one of (a) ester-containing by-products from the manufacture of dimethyl terephthalate, (b) scrap polyalkylene terephthalates, (c) phthalic anhydride, (d) residues from the manufacture of phthalic anhydride, (e) terephthalic acid, (f) residues from the manufacture of terephthalic acid, (g) isophthalic acid, (h) trimellitic anhydride and residue from the manufacture of, (i) aliphatic polybasic acids or esters derived therefrom, and (j) by-products from the manufacture of polyalkylene terephthalate.

19. The process of claim 16 or 17 wherein said glycol comprises ethylene glycol, propylene glycol, diethylene glycol, triethylene glycol, polyethylene glycol, dipropylene glycol, or a mixture thereof.

20. The process of claim 16 or 17 wherein said reacting comprises:
(i) an initial reaction at a pressure from 560 mmHg to atmospheric pressure; and
(ii) a completion reaction at a vacuum pressure of 50 to 200 mmHg or an azeotrope distillation using cyclohexane.

21. The process of claim 16 or 17 wherein said metal esterification catalyst comprises manganese acetate, antimony oxide, lead oxide, tin chloride, tin oxide, a titanate, or a combination thereof.

22. The process of claim 16 or 17 wherein said non-alkoxylated aminoalcohol is a non-alkoxylated tertiary aminoalcohol.

23. The process of claim 22 wherein said non-alkoxylated tertiary aminoalcohol is triethanolamine.

24. The process of claim 16 or 17 wherein said reaction mixture further comprises a functionality enhancing component having a hydroxyl equivalent weight of 15 to 70.

25. The process of claim 24 wherein said functionality enhancing component comprises a non-alkoxylated glycerol, pentaerythritol, α-methylglucoside, sucrose, sorbitol, tri-methylolpropane, trimethylolethane, a tertiary aminoalcohol, or a mixture thereof.

26. A process for making a foam, comprising reacting the aromatic polyester polyol of claim 1 with an organic polyisocyanate in the presence of a surfactant and a blowing agent.

27. A process for making a foam, comprising reacting the aromatic polyester polyol of claim 9 with an organic polyisocyanate in the presence of a surfactant and a blowing agent.

28. A process for making a foam, comprising:
(a) obtaining an aromatic polyester polyol having an acid number below 3.0 mg/KOH/g, wherein said aromatic polyester polyol is the reaction product of a reaction mixture comprising:
an acid component;
a glycol component; and
a metal esterification catalyst,
wherein said reaction product further comprises at least one of residue metal esterification catalyst and glycolates, carboxylates, and other coordination compounds of the metal; and
(b) reacting said aromatic polyester polyol with an organic polyisocyanate in the presence of a surfactant and a blowing agent,
wherein said at least one of the residue metal esterification catalyst and glycolates, carboxylates, and other coordination compounds of the metal is not substantially removed prior to said reacting.

29. The process of claim 28 wherein said reaction mixture further comprises a non-alkoxylated aminoalcohol.
